(19) United States
(12) Patent Application Publication
(10) Pub. No.: US 2007/0052853 A1
(43) Pub. Date: Mar. 8, 2007

(54) METHOD AND APPARATUS FOR INSTANT REPLAY OF DIGITAL BROADCAST DATA

(76) Inventors: Tsuei-Chi Yeh, Hsinchu (TW); Chi-Fu Huang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/163,279

(22) Filed: Oct. 12, 2005

(30) Foreign Application Priority Data
Aug. 26, 2005 (TW) 94129201

(51) Int. Cl. H04N 5/44

(52) U.S. Cl. 348/559

(57) ABSTRACT

A method and an apparatus for instant replay of digital broadcast data are disclosed. The method provides a function to multiplex the code stream of the digital broadcast data is provided by using software. During playing a digital broadcast program, the digital broadcast data within the period of time from present to former several seconds are recorded simultaneously. Hence, when the users see a marvelous frame or a remarkable message, they may ask for rebroadcasting the former frames by sending a replay order. Moreover, the instant replay apparatus can be applied in the display equipments such as the digital televisions or the setup boxes. Therefore, without using the hard disk or the video recorder, the method can achieve the purpose of instantly replaying the extraordinary frames.

### CROSS-REFERENCE TO RELATED APPLICATION

This application claims the priority benefit of Taiwan application serial no. 941 29201, filed on Aug. 26, 2005. All disclosure of the Taiwan application is incorporated herein by reference.

### BACKGROUND OF THE INVENTION

1. Field of the Invention

The present invention relates to a method and an apparatus for playing the digital data, and more particularly, to a method and an apparatus for instant replay of digital broadcast data by preserving the digital broadcast data.

2. Description of the Related Art

The television broadcast has been digitalized, and the television programs are manufactured and transmitted by digital compression. By using such digitalization technique, it does not only provide video signals with higher quality, but also eliminates the defects of the video distortion or blurs caused by the signal interference in the conventional television.

Generally speaking, while watching the television programs, if the users know the program shcedule in advance, in order to preserve the fabulous program clip or to adapt with the user's personal schedule, it is often that the users use the recording equipment to record the programs first and watch the recorded programs later. However, the programs are recorded only when the recording equipment for recording the programs is activated in advance.

Nevertheless, the marvelous frame or the remarkable message is usually displayed only at a moment, even though the users desire to use the recording equipment to record, the recording equipment starts to work only at the moment when the users press the “record” button. Unfortunately, the marvelous frame had been displayed already, thus it is too bad for the users not able to instantly record the former marvelous frames.

If there is a mechanism for quickly activating the instant replay function, when the users see a marvelous frame or a remarkable message or they had just been displayed, the users still can quickly activate the instant replay function to replay them, thus the users will not feel disappointed for missing the marvelous frame or the remarkable message.

### SUMMARY OF THE INVENTION

Therefore, it is an object of the present invention to provide a method for instantly replaying the digital broadcast data. Through preserving the digital broadcast data within a certain period of time from present to former, the method can replay the preserved digital broadcast data after receiving a replay order, so as to achieve the object of instantly replaying the extraordinary frames.

It is another object of the present invention to provide an apparatus for instantly replaying the digital broadcast data. By using a storage unit to store the digital broadcast data within a certain period of time from present to former, the apparatus can replay the preserved digital broadcast data after receiving a replay order, so as to achieve the object of instantly replaying the extraordinary frames.

The present invention provides a method for instantly replaying the digital broadcast data. First, a record of digital broadcast data is continuously received. Then, the digital broadcast data is played and the digital broadcast data within a certain period of time from present to former is preserved. Finally, the preserved digital broadcast data is replayed after a replay order is received.

In the method for instantly replaying the digital broadcast data according to a preferred embodiment of the present invention, after the digital broadcast data is continuously received, the digital broadcast data is further multiplexed to a decoder and a memory. Then, the digital broadcast data is decoded by the decoder. Finally the digital broadcast data is stored in the memory.

In the method for instantly replaying the digital broadcast data according to the preferred embodiment of the present invention, wherein when the memory is full of digital broadcast data, the preserved digital broadcast data is continuously updated with the digital broadcast data within a certain period of time from present to former.

In the method for instantly replaying the digital broadcast data according to the preferred embodiment of the present invention, wherein the length of the period of time mentioned above is determined by the capacity of the memory.

In the method for instantly replaying the digital broadcast data according to the preferred embodiment of the present invention, before the preserved digital broadcast data is replayed, the digital broadcast data stored in the memory is further transmitted back to the decoder, and then the digital broadcast data is decoded by the decoder.

In the method for instantly replaying the digital broadcast data according to the preferred embodiment of the present invention, wherein the memory mentioned above is a random access memory (RAM).

In the method for instantly replaying the digital broadcast data according to the preferred embodiment of the present invention, wherein the decoder mentioned above is a motion picture experts group (MPEG) decoder.

An apparatus for instantly replaying the digital broadcast data provided by the present invention comprises a receiver, a memory, a decoder, a player, and a controller. The receiver continuously receives a record of digital broadcast data. The memory stores the digital broadcast data, wherein when the memory is full of digital broadcast data, the preserved digital broadcast data is continuously updated with the digital broadcast data within a certain period of time from present to former. In addition, the decoder decodes the digital broadcast data, and the player coupled to the decoder plays the decoded digital broadcast data. A controller coupled to the receiver, the memory, and the decoder multiplexes the digital broadcast data received by the receiver to the memory and the decoder, and transmits the digital broadcast data stored in the memory back to the decoder after receiving a replay order.

In the method of the present invention, a function to multiplex the code stream of the digital broadcast data is provided by software. During playing a digital broadcast program, the digital broadcast data within the period of time from present to former several seconds are recorded simultaneously. Accordingly, the preserved digital broadcast data can be replayed after receiving a replay order, so as to achieve the purpose of instantly replaying the extraordinary frames.

### BRIEF DESCRIPTION DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a block diagram of an apparatus for instantly replaying the digital broadcast data according to a preferred embodiment of the present invention.

FIG. 2 schematically shows a flow chart illustrating a method for instantly replaying the digital broadcast according to a preferred embodiment of the present invention.

FIG. 3 schematically shows a detail block diagram of a digital television with an instant replay function according to a preferred embodiment of the present invention.

### DESCRIPTION PREFERRED EMBODIMENTS

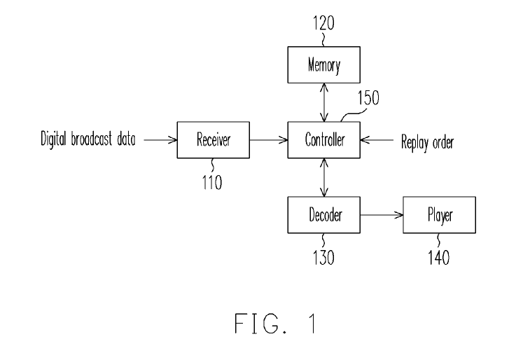

FIG. 1 schematically shows a block diagram of an apparatus for instantly replaying the digital broadcast data according to a preferred embodiment of the present invention. Referring to FIG. 1, the present embodiment includes a receiver 110, a memory 120, a decoder 130, a player 140, and a controller 150. Wherein, the memory 120 may be a random access memory (RAM), and the decoder 130 may be a motion picture experts group (MPEG) decoder. It will be apparent to one of the ordinary skill in the art that modifications to the described embodiment may be made without departing from the spirit of the invention. For example, other types of memory and decoder may be used by the user in the present invention in consideration of the physical requirement.

Referring to FIG. 1, first the receiver 110 receives a record of digital broadcast data from the external. Wherein, the digital broadcast data is digitalized and transmitted to the receiver 110 in a format of a long series of data packets. Then, the code stream where the digital broadcast data is recorded is multiplexed to the memory 120 and the decoder 30 through the controller 150.

Meanwhile, the decoder 130 decodes the digital broadcast data according to the encoding method of the received digital broadcast data, and the decoded digital broadcast data is transmitted to the player 140 for users to watch.

However, while playing the digital broadcast data, the memory 120 begins to record the multiplexed digital broadcast data, and when the memory is full of digital broadcast data, the preserved digital broadcast data is continuously updated with the digital broadcast data within a certain period of time from present to former. For example, if the maximum length of the digital broadcast data can be stored in the memory 120 is 10 seconds and the memory is full of digital broadcast data now, the data recorded within one second from present to former needs to be erased before the new data of the next second can be recorded, and the remaining free space obtained from the deletion is used to store the new data of the next second. With such repeatedly erasing old data and recording new data, the digital broadcast data stored in the memory 120 can maintain as the most up-to-date state, so as to fulfill the requirement of replaying the extraordinary frames for the users based on their preference at any time.

It is to be noted that the maximum recording time of the memory 120 depends on the capacity of the memory 120. Using a digital program with a certain period of time length as an example, the compression rate of the data is about 31.14, assuming it is a PAL television system, the MPEG code rate is about 4 Mbps. Therefore, 1 MB memory can record a program of two seconds, and a program of 10 seconds requires 5 MB memory, and others applying the same. However, the present invention has no intention to limit the memory capacity, any appropriate capacity of memory can be selected by the users to store the program with a certain period of time length in consideration of the physical requirement.

Then, when the users are watching the digital broadcast program, in case the users see a marvelous frame (e.g. a nice catch in a baseball game) or a remarkable message (e.g. breaking news of a hurricane), they may press a replay button for sending a replay order to the controller 150. Meanwhile, the controller 150 transmits the digital broadcast data stored in the memory 120 back to the decoder 130, and the digital broadcast data is transmitted to the player 140 for replaying later after decoded by the decoder 130, such that the users do not miss any fabulous frames.

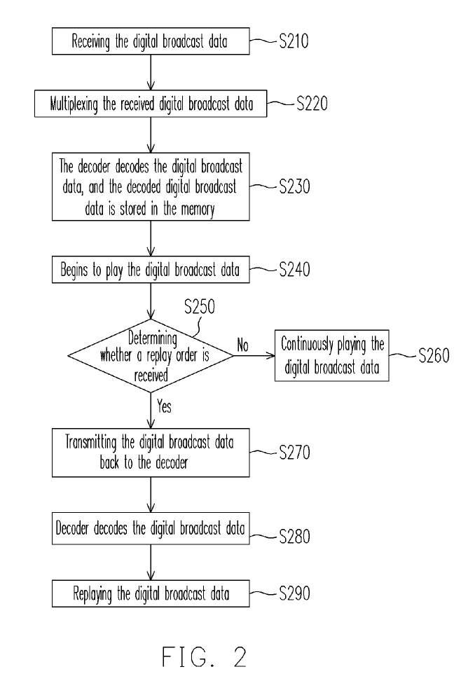

FIG. 2 schematically shows a flow chart illustrating a method for instantly replaying the digital broadcast data according to a preferred embodiment of the present invention. The detail steps from receiving the digital broadcast data to instantly replaying the program clip are described in greater detail with referring to FIG. 2 hereinafter, such that a convenient instant replay method is provided.

First, a record of digital broadcast data is continuously received from the external (step S210). Wherein, the digital broadcast data may be a long series of data packets transmitted from the satellites or cables, and the content of the digital broadcast data contains the digital compressed broadcast program.

Then, the received digital broadcast data is multiplexed to a decoder and a memory (step S220). Wherein, the memory may be a random access memory (RAM), and the decoder may be a motion picture experts group (MPEG) decoder, but not necessarily limited by it.

Afterwards, the decoder decodes the digital broadcast data, and the decoded digital broadcast data is stored in the memory (step S230). After the digital broadcast data is decoded by the decoder, the decoded digital broadcast data begins to play (step S240). Wherein, when the memory is full of digital broadcast data, the preserved digital broadcast data is continuously updated with the digital broadcast data within a certain period of time from present to former. The maximum recording time of the memory depends on the capacity of the memory, since it had been described detailedly in the previous embodiment, its detail is omitted herein.

While playing the digital broadcast data, it starts to detect and determine whether a replay order is received (step S250). If the replay order is not received yet, the digital broadcast data is continuously played (step S260).

On the other hand, once a replay order is received, the digital broadcast data stored in the memory is transmitted back to the decoder (step S270). Similarly, the digital broadcast data is then decoded by the decoder (step S280), and the decoded digital broadcast data is replayed (step S290).

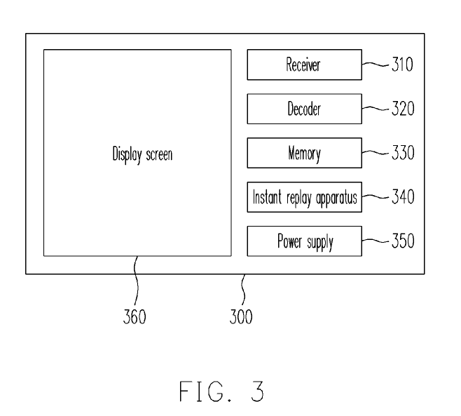

FIG. 3 schematically shows a detail block diagram of a digital television with an instant replay function according to a preferred embodiment of the present invention. Referring to FIG. 3, the instant replay apparatus described in the previous embodiment is configured in a general digital television in the present embodiment, such that the digital television can instantly replay the marvelous frame or the remarkable message. Wherein, the digital television mentioned above maybe a cathode ray tube (CRT) television, a liquid crystal display (LCD) television, or a plasma television, but not necessarily limited by it. Moreover, the user can apply the present invention into other type of television or display equipment such as the setup box.

Referring to FIG. 3, besides a receiver 310, a decoder 320, a memory 330, a power supply 350, and a display screen 360, which are the general components of a general digital television, the digital television 300 of the present embodiment further includes an instant replay apparatus 340, such that the digital television 300 can instantly replay the fabulous frames. Wherein, the receiver 310 receives the digital broadcast data from the external satellites or cables, and the decoder 320 decodes the received digital broadcast data. Then, the decoded digital broadcast data is played on the display screen 360 for users to watch.

In addition, the memory 330 stores software and system data such as the configuration files required for performing various functions by the digital television 300. Wherein, the memory 330 may be an electrically erasable programmable read-only memory (EEPROM) or other types of memory, but not necessarily limited by it. The power supply 350 provides the electric power required by the digital television 300.

In addition to the basic functions provided by the general digital television mentioned above, the instant replay function provided by the digital television 300 of the present embodiment is described in greater detail hereinafter. First, while the digital television 300 is playing the digital broadcast data, the instant replay apparatus 340 receives the same digital broadcast data multiplexed by the receiver 310, and starts to store the received digital broadcast data. Meanwhile, when the instant replay apparatus 340 is full of digital broadcast data, the preserved digital broadcast data is continuously updated with the digital broadcast data within a certain period of time from present to former.

If a replay order is received while playing the digital broadcast data, the digital television 300 transmits the digital broadcast data stored in the instant replay apparatus 340 back to the decoder 320. After the digital broadcast data is decoded by the decoder 320, the decoded digital broadcast data is transmitted to the display screen 360 and displayed on it. Through the steps mentioned above, the digital television 300 can provide the instant replay function.

In summary, in the method and the apparatus for instant replay of the digital broadcast data provided by the present invention, a function to multiplex the code stream of the digital broadcast data is provided by software. During playing a digital broadcast program, the digital broadcast data within the period of time from present to former several seconds are recorded simultaneously. Hence, when the users see a marvelous frame or a remarkable message, a mechanism is provided for the users to replay the former fabulous frames previously missed, such that the object of instantly replaying the extraordinary frames is achieved.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A method for instantly replaying the digital broadcast data, comprising:
continuously receiving the digital broadcast data;
broadcasting the digital broadcast data and preserving the digital broadcast data within a certain period of time from present to former; and
replaying the preserved digital broadcast data after receiving a replay order.

2. The method for instantly replaying the digital broadcast data of claim 1, wherein after the step of continuously receiving the digital broadcast data, further comprises:
multiplexing the digital broadcast data into a decoder and a memory;
decoding the digital broadcast data by the decoder; and
storing the digital broadcast data in the memory.

3. The method for instantly replaying the digital broadcast data of claim 2, wherein when the memory is full of digital broadcast data, the preserved digital broadcast data is continuously updated with the digital broadcast data within a certain period of time from present to former.

4. The method for instantly replaying the digital broadcast data of claim 3, wherein the length of the period of time is determined by the capacity of the memory.

5. The method for instantly replaying the digital broadcast data of claim 2, wherein before the step of replaying the preserved digital broadcast data, further comprises:
transmitting the digital broadcast data stored in the memory back to the decoder; and
decoding the digital broadcast data by the decoder.

6. The method for instantly replaying the digital broadcast data of claim 2, wherein the memory comprises a random access memory (RAM).

7. The method for instantly replaying the digital broadcast data of claim 2, wherein the decoder comprises a motion picture experts group (MPEG) decoder.

8. An apparatus for instantly replaying the digital broadcast data, comprising:
a receiver for continuously receiving the digital broadcast data;
a memory for storing the digital broadcast data, wherein when the memory is full of digital broadcast data, the preserved digital broadcast data is continuously updated with the digital broadcast data within a certain period of time from present to former;
a decoder for decoding the digital broadcast data;
a player coupled to the decoder for playing the decoded digital broadcast data; and
a controller coupled to the receiver, the memory, and the decoder for multiplexing the digital broadcast data received by the receiver into the memory and the decoder, and transmitting the digital broadcast data stored in the memory back to the decoder after receiving a replay order.

9. The apparatus for instantly replaying the digital broadcast data of claim 8, wherein the length of the period of time is determined by the capacity of the memory.

10. The apparatus for instantly replaying the digital broadcast data of claim 8, wherein the memory comprises a random access memory (RAM).

11. The apparatus for instantly replaying the digital broadcast data of claim 8, wherein the decoder comprises a motion picture experts group (MPEG) decoder.

12. A digital television with an instant replay function, comprising:
a receiver for continuously receiving the digital broadcast data;
a decoder for decoding the digital broadcast data;
a display screen for displaying the decoded digital broadcast data; and
an instant replay apparatus coupled to the receiver and the decoder for preserving the digital broadcast data within a certain period of time from present to former, and transmitting the preserved digital broadcast data back to the decoder after receiving a replay order.

13. The digital television with the instant replay function of claim 12, further comprising:
a memory for storing system information of the digital television.

14. The digital television with the instant replay function of claim 13, wherein the memory comprises an electrically erasable programmable read-only memory (EEPROM).

15. The digital television with the instant replay function of claim 12, further comprising:
a power supply for providing an electric power required by the normal operation of the digital television.

16. The digital television with the instant replay function of claim 12, wherein the decoder comprises a motion picture experts group (MPEG) decoder.

17. The digital television with the instant replay function of claim 12, wherein the digital television comprises one of a cathode ray tube (CRT) television, a liquid crystal display (LCD) television, and a plasma television.
